(19) United States
(12) Patent Application Publication
(10) Pub. No.: US 2013/0341328 A1
(43) Pub. Date: Dec. 26, 2013

(54) WASTE CONTAINER WITH ODOR CONTROL

(71) Applicants: David J. Schneider, Union, KY (US); Charles A. Schneider, Villa Hills, KY (US)

(72) Inventors: David J. Schneider, Union, KY (US); Charles A. Schneider, Villa Hills, KY (US)

(21) Appl. No.: 13/975,767

(22) Filed: Aug. 26, 2013

Related U.S. Application Data
(63) Continuation-in-part of application No. 13/049,993, filed on Mar. 17, 2011.

(51) Int. Cl. B65F 1/14

(52) U.S. Cl. CPC B65F 1/1615; B65F 1/1646
USPC 220/259.2

(57) ABSTRACT

Waste containers which include a vessel body with an opening for receiving waste materials, a removable cover/lid for operably enclosing said opening, and an odor control dispenser are disclosed. The odor control dispenser selectively dispenses an odor control agent into the vessel body when activated.

### CROSS-REFERENCE TO RELATED APPLICATIONS

This application is a continuation-in-part of U.S. patent application Ser. No. 13/049,993, filed Mar. 17, 2011. The disclosure of that application is hereby incorporated by reference in its entirety.

### BACKGROUND

The present disclosure, in various embodiments, is directed to waste containers, such as pet waste receptacles, trash receptacles, diaper pails, compost containers, and medical waste containers, and the like, with odor control. The waste containers not only contain odors but also neutralize and reduce odors emitted waste materials contained therein.

Enclosed waste containers are frequently used to dispose of materials which emit generally continuous unpleasant and even noxious odors. Many people have a limited means to dispose of waste, i.e. once-weekly residential garbage pickup. To reduce costs associated with garbage bags, extra garbage pickups, etc., waste containers are typically used to receive many loads of waste prior to being emptied. Between depositions of each load, the already deposited contents tend to decay further, thus increasing the foulness of the odors emitted.

This problem is particularly bad for biological waste materials such as animal urine and feces, litter, diapers, medical waste, and meat. However, even materials which do not emit repugnant smells when first disposed of in a waste container tend to become increasingly odorous after disposal. Waste containers are often stored indoors where the smells are confined. Thus, the smells tend to linger even after the covers of the waste containers are closed and the people who dispose of the waste are not the only people who are exposed the odor.

Therefore, it would be desirable to develop a waste container which reduces or controls the odors emitted from the waste contents of the container.

### BRIEF DESCRIPTION

The present application discloses, in various embodiments, waste containers. The waste containers comprise an enclosed waste holding receptacle and an odor control dispenser. The odor control dispenser releases an odor control composition comprising a specific odor control agent when activated. The odor control agent reacts with odor-generating molecules of the waste material to neutralize and reduce odor produced thereby.

Disclosed in embodiments is a waste container comprising a vessel body, a cover, and an odor control dispenser. The vessel body includes an opening for receiving waste materials. The removable cover operably encloses said opening. The odor control dispenser selectively dispenses an odor control agent into the vessel body upon activation. In certain embodiments, the odor control dispenser may continuously release a vaporized odor control composition and/or may release an odor control composition when the cover is set in motion in relation to the vessel body.

The odor control dispenser may also release an odor control composition upon activation of a trigger. In some embodiments, the odor control composition may be vaporized or atomized upon dispensing. The odor control composition reacts with the odor-causing molecules produced by the waste materials to reduce the odor.

In other embodiments, the waste container may further include a second or further additional odor control dispensers. For example, the second odor control dispenser may continuously release a vaporized or atomized odor control composition and/or may release an odor control composition when the cover is set in motion in relation to the vessel body.

The vessel body and cover may be pivotally connected by a hinge or may be slidably engaged.

The odor control dispenser contains a specific odor control composition. The odor control composition does not mask the odor produced by the waste material, but, instead reacts with the odor-generating molecules to neutralize or reduce the odor produced thereby.

The odor control agent may be a compound of Formula (II):

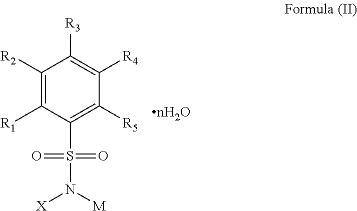

wherein X is a halogen; wherein R₃ is hydrogen, methyl, or COOM; wherein R₁, R₂, R₄, R₅ are independently hydrogen, COOH, derivatized COOH, an ester or alkylated amide, COOM, CN, NO₂, SO₃H or derivatized SO₃R, a halogen, a substituted or unsubstituted phenyl group, a sulfonamide, a halosulfonamide, a straight or branched aliphatic moiety from C₁ to C₁₂, wherein, the same straight or branched aliphatic moiety may contain substitution at one or more of the aliphatic hydrogens; wherein R is hydrogen or substituted or unsubstituted C₁-C₁₂ alkyl; wherein R₁, R₂, R₄ and R₅ are other than all hydrogen; and wherein M is an alkali or alkaline earth metal.

The odor control agent may also be a compound of Formula (III):

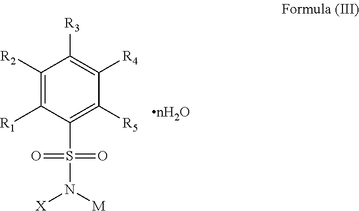

wherein X is a halogen; wherein R₁, R₂, R₄, R₅ are independently hydrogen, COOH, derivatized COOH, an ester or alkylated amide, COOM, CN, NO₂, SO₃H or derivatized SO₃R, a halogen, a substituted or unsubstituted phenyl group, a sulfonamide, a halosulfonamide, a straight or branched aliphatic moiety from C₁ to C₁₂, wherein, the same straight or branched aliphatic moiety may contain substitution at one or more of the aliphatic hydrogens; wherein R₃ is an organic derivatized COOH, such as an ester or alkylated amide, CN, NO₂, SO₃H or derivatized SO₃R, a halogen, a substituted or unsubstituted phenyl group, a sulfonamide, a halosulfonamide, a straight or branched aliphatic moiety from C₂ to C₁₂, wherein, the same straight or branched aliphatic moiety may contain substitution at one or more of the aliphatic hydrogens; wherein R is hydrogen or substituted or unsubstituted C₁-C₁₂ alkyl; and wherein M is an alkali or alkaline earth metal.

The odor control composition may comprise an odor control agent selected from chloramine T, chloramine B, N-chloro-4-carboxybenzenesulfonamide, and mixtures thereof. In some embodiments, the odor control agent is a mixture of chloramine T and N-chloro-4-carboxybenzenesulfonamide. In other embodiments, the odor control agent is a mixture of chloramine B and N-chloro-4-carboxybenzenesulfonamide. The odor control composition may further comprise a disinfectant.

In some embodiments, the odor control agent is a polymer of Formula (VI):

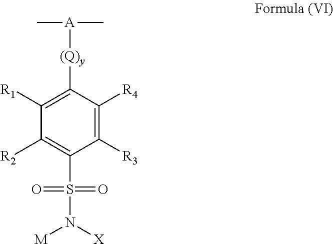

wherein A is a trivalent linkage; wherein Q is a divalent linkage and y is 0 or 1; wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens; wherein X is halogen; and wherein M is an alkali or alkaline earth metal.

In some embodiments, the waste container is a pet waste receptacle, a trash receptacle, a diaper pail, a compost container, or a medical waste container.

Also disclosed herein is a waste container comprising a vessel body with an opening for receiving waste materials, a cover connected to the vessel body for operably enclosing said opening, and an odor control dispenser for selectively dispensing an odor control agent into the vessel body upon activation. The cover comprises a plurality of flexible flaps configured to allow the ingress of a waste material into the vessel body.

The odor control dispenser may continuously release an odor control composition. The odor control dispenser may also release an odor control composition upon activation of a trigger. The trigger may be activated when the flaps are flexed to receive the waste material.

Still further disclosed is a waste container comprising a vessel body with an opening for receiving waste materials, a hinged cover mounted on said vessel body for operably enclosing said opening, an odor control dispenser for selectively dispensing an odor control agent into the vessel body upon activation, and a foot pedal operably connected to the hinged cover for opening and closing the cover and activating the dispenser.

Disclosed in other embodiments is a waste container comprising a vessel body with an opening for receiving waste materials, a cover pivotally connected to said vessel body for operably enclosing said opening, and an odor control dispenser for selectively dispensing an odor control agent into the vessel body upon activation. Activation occurs when the cover is pivotally opened or closed.

Activation may occur mechanically when the cover is opened or closed. In embodiments, activation occurs mechanically when the cover engages or disengages a mechanical switch on the vessel body. Activation may also occur electronically via an electronic switch which is engaged when the cover is opened or closed. In other embodiments, activation occurs when a light sensitive switch is engaged when the cover is opened or closed. A torsion spring may assist in the opening and closing of the cover.

The odor control dispenser may comprise a cartridge. The cartridge may be removable and/or refillable.

Also disclosed is a waste container comprising a vessel body with an opening for receiving waste materials, a cover connected to said vessel body for operably enclosing said opening, an odor control dispenser for selectively dispensing an odor control agent into the vessel body upon activation. The cover comprises an attachment portion and a lid. The lid and the attachment portion are pivotally connected by a hinge. The attachment portion may snap onto the top of the vessel body.

Activation may occur when the lid is pressed down. A torsion spring may control the opening and closing of the lid.

Alternatively, activation may occur when a button is pressed. The button may be on top of the lid. The button may also be located on an inner lip of the attachment portion.

Activation may occur mechanically via opening and/or closing the lid. Activation may also occur electronically via an electronic switch attached to cover. In some embodiments, activated occurs when a light-sensitive switch is turned on.

Also disclosed in various embodiments herein is a waste container comprising: an outer vessel body having a base at a lower end, an upper end with an opening, a hinge support section extending outwards from a rear end on the upper end, and an exterior semicylindrical surface below the hinge support section; an inner lid for operably sealing the opening of the outer vessel body, the inner lid including a door; and an outer lid that covers the inner lid.

The door of the inner lid may be configured to open into the inner vessel when contacted with a force exceeding a predetermined threshold force.

The outer vessel body and the outer lid can be pivotally connected by a hinge in the hinge support section. The hinge may be connected to a foot pedal located at the base of the outer vessel body at a front end of the outer vessel body.

The inner lid may further comprise one or more locking tabs that engage the outer vessel body. The inner lid can further comprise a fingerhold on a front end of the inner lid.

The waste container sometimes further comprises an outer lid locking mechanism that maintains the outer lid in an unlocked configuration when the locking mechanism is in a first position and maintains the outer lid in a closed locked configuration when the locking mechanism is in a second position.

The exterior semicylindrical surface may be part of a cylindrical cavity designed to hold an associated odor control dispenser. The outer lid can further comprise a spray button operably configured to depress over the cylindrical cavity. The inner lid may further comprise a cutout configured to permit access to the cylindrical cavity when the inner lid is operably sealing the opening of the outer vessel body.

An upward lip may be present on the upper end on an interior surface of the outer vessel body.

The waste container may further comprise an inner vessel body that fits in the outer vessel body. A downward lip can be present on an upper end of an exterior surface of the inner vessel body. An upward lip can be present on the upper end on an interior surface of the outer vessel body, and the upward lip and the downward lip can engage each other. Alternatively, the inner lid may further comprise a circumferential wall that engages the downward lip.

The waste container may further comprise an odor control dispenser that is adapted to fit in a cylindrical cavity, wherein the exterior semicylindrical surface is part of a cylindrical sidewall surrounding the cylindrical cavity. The waste container can be used as a pet waste receptacle, a trash can, a diaper pail, a compost container, or a medical waste container.

Also disclosed herein is a waste container, comprising: an outer vessel body having a base at a lower end, an upper end with an opening, a hinge support section extending outwards from a rear end on the upper end, a cylindrical sidewall that forms an exterior semicylindrical surface below the hinge support section, and an upward lip on the upper end of an interior surface; an inner lid for operably sealing the opening of the outer vessel body, the inner lid including a door and a circumferential sidewall; an outer lid that covers the inner lid; an inner vessel body that fits in the outer vessel body, the inner vessel body having a downward lip on an upper end of an exterior surface; wherein the upward lip of the outer vessel body, the downward lip of the inner vessel body, and the circumferential sidewall of the inner lid are configured to engage each other.

The waste container may further comprise an odor control dispenser, wherein the outer lid further comprises a spray button operably configured to depress a button on the odor control dispenser; wherein the cylindrical sidewall surrounds a cylindrical cavity in which the odor control dispenser can be placed; and wherein the inner lid further comprises a cutout configured to permit access to the cylindrical cavity when the inner lid is operably sealing the opening of the outer vessel body.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side cutaway view of a first embodiment of a waste container of the present disclosure.

FIG. 2 is a side cutaway view of a second embodiment of a waste container of the present disclosure.

FIG. 3 is a top perspective view of a third embodiment of a waste container of the present disclosure.

FIG. 4 is a side cutaway view of a fourth embodiment of a waste container of the present disclosure.

FIG. 5 is a top perspective view of a fifth embodiment of a waste container of the present disclosure.

FIG. 6 is a side perspective view of a sixth embodiment of a waste container of the present disclosure.

FIG. 7A is a top cutaway view of an upper portion of the waste container of FIG. 6.

FIG. 7B is a blow-up view of the hinge mechanism of the waste container of FIGS. 6 and 7A.

FIG. 7C is a blow-up view of the activation button of the waste container of FIGS. 6, 7A, and 7B.

FIG. 8 is a side cutaway view of the upper portion of the waste container of FIGS. 6 and 7.

FIG. 9 is an exterior side view of another exemplary embodiment of a waste container of the present disclosure.

FIG. 10 is an exterior rear perspective view of the waste container of FIG. 9, showing a cylindrical contour for housing the odor control dispenser.

FIG. 11 is an exterior top view of the waste container of FIG. 9, showing the outer cover.

FIG. 12 is a magnified view of a locking mechanism for the waste container of FIG. 9.

FIG. 13 is a top perspective view of the waste container of FIG. 9, showing the inner cover.

FIG. 14 is a top perspective view of the waste container of FIG. 9 with the outer cover and the inner cover removed to show the odor control dispenser and the inner vessel body.

FIG. 15 is a rear perspective view of the waste container of FIG. 9 with the outer cover and the inner cover removed to show the odor control dispenser and the inner vessel body.

FIG. 16 is a top perspective view of the waste container of FIG. 9 with the outer cover, the inner cover, the inner vessel, and the odor control dispenser removed to show the interior of the outer vessel body.

FIG. 17 is a front cross-sectional view of the waste container of FIG. 9.

FIG. 18 is a side cross-sectional view of the waste container of FIG. 9.

FIG. 19 is a perspective view illustrating the opening of the outer cover of the waste container of FIG. 9 using the foot pedal.

FIG. 20 is a rear perspective view showing the use of the locking mechanism of the waste container of FIG. 9.

FIGS. 21A-21C are views illustrating the removal of the inner vessel from the outer vessel of the waste container of FIG. 9.

FIGS. 22A-22C are views illustrating the installation and removal of a liner in the waste container of FIG. 9.

FIG. 23 is a top perspective view illustrating how the odor control dispenser is installed and removed from the waste container of FIG. 9.

FIG. 24 is a top perspective view illustrating how the spray button in the outer cover of the waste container of FIG. 9 can be locked and unlocked.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

As used herein, the term “odor control agent” or “odor control composition” refers to a chemical which reacts with odor-causing molecules to reduce or eliminate odor. Odor control agents are distinguished from deodorants and fragrances which mask the odor but do not react with the odor-causing molecules.

The disclosure relates to waste containers comprising a vessel body, a removable cover, and an odor control dispenser. The vessel body includes an opening for receiving waste materials. The cover operably encloses said opening. The odor control dispenser is configured to selectively dispense an odor control composition which comprises at least one odor control agent. Release of the odor control composition is generally performed by spraying the odor control composition out of the odor control dispenser. The composition is released as a vapor or spray or is vaporized or atomized after being sprayed. The waste containers of the present disclosure are useful for neutralizing offensive odors emitted by the waste.

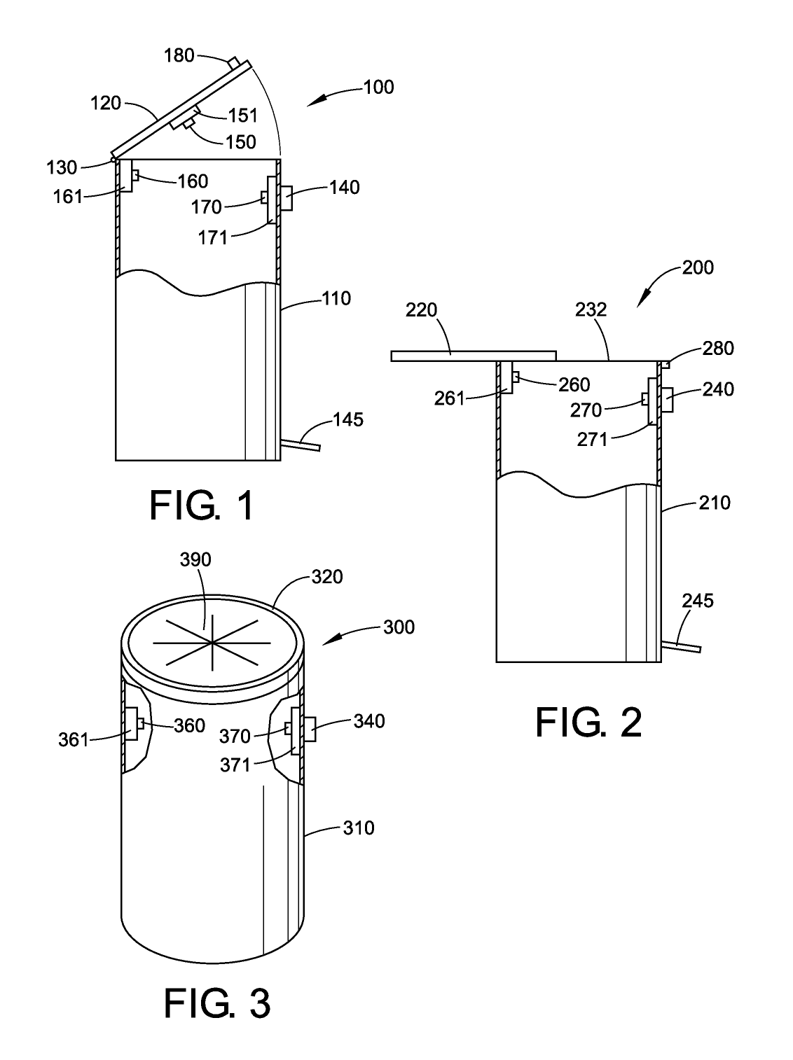

FIG. 1 shows a first embodiment of a waste container 100 of the present disclosure. The waste container 100 comprises a vessel body 110 and a cover 120. A hinge 130 connects the cover 120 to the vessel body 110. The waste container also comprises three odor control dispensers 150, 160, and 170. Each dispenser draws an odor control composition from a different odor control reservoir 151, 161, and 171. In the depicted embodiment, the first odor control dispenser 150 is attached to the cover 120. This particular odor control dispenser 150 continuously releases the odor control composition contained in the reservoir 151. The odor control dispenser which continuously releases the odor control composition may alternatively be attached the interior of the vessel body. The second odor control dispenser 160 draws an odor control composition from reservoir 161 and is configured to release a portion of the composition into the vessel body 110 when the cover 120 is set in motion in relation to the vessel body 110, i.e. when the cover 120 is opened. The second odor control dispenser 160 may be configured to release the odor control composition when the cover 120 makes any movement with respect to the vessel body 110 or alternatively may be configured to release the odor control composition when a threshold angle between the cover 120 and the top of the vessel body 110 is reached. In some embodiments, the amount of odor control composition released may be a function of the angle between the cover 120 and the top of the vessel body 110. For example, the odor control dispenser 160 may release odor control composition at a higher rate when the cover is barely open and little or no odor control composition when the cover is fully open. The third odor control dispenser 170 draws an odor control composition from reservoir 171 and is configured to release the composition upon activation of a trigger. The trigger may for example be a button 140 or a foot pedal 145. When the button 140 or the foot pedal 145 is pressed, the odor control dispenser releases a portion of the odor control composition. An optional meter 180 displays the amount of odor control composition remaining in each of the reservoirs 151, 161, and 171. Further optionally, the meter may produce a signal when the amount of odor control composition falls below a predetermined level. The signal may be a visual signal or an auditory signal.

FIG. 2 illustrates a second embodiment of a waste container 200 of the present disclosure. The waste container 200 comprises a vessel body 210 and a cover 220. The cover 220 slides across the vessel body 210 via a rail 232. The waste container 200 comprises an odor control dispenser 260 which draws an odor control composition from a reservoir 261 and releases a portion of the odor control composition when the cover 220 slides past a predetermined point with respect to the vessel body 210. The depicted embodiment also includes a second odor control dispenser 270 which draws odor control composition from a second reservoir 271 and releases a portion of the odor control composition when a trigger is activated, e.g. when a button 240 or a foot pedal 245 is pressed. The waste container 200 also includes a meter 280.

FIG. 3 depicts a third embodiment of a waste container 300 of the present disclosure. The waste container 300 includes a vessel body 310 and a cover 320 defining a top portion of the waste container 300. The cover 320 comprises a plurality of flexible flaps 390. Waste may be placed in the vessel body 310 by pushing the waste through the flexible flaps 390 in the cover 320. After the waste material is placed into the vessel body 310, the flaps return to a closed position. The flaps 390 may be comprised of rubber or any other material which is capable of forming a seal when the flaps 390 are in a first position, i.e. when there is no pressure on the flaps 390, and forming an opening when pressure is applied to the flaps 390. The waste container 300 further comprises a first odor control dispenser 360 which draws an odor control composition from a reservoir 361 and releases a portion of the odor control composition when a waste material is being disposed of in the vessel body 310. Alternatively, the odor control dispenser 360 may be configured to continuously release the odor control composition. A second odor control dispenser 370 draws an odor control composition from reservoir 371 and releases a portion of the composition when a button 340 is pressed.

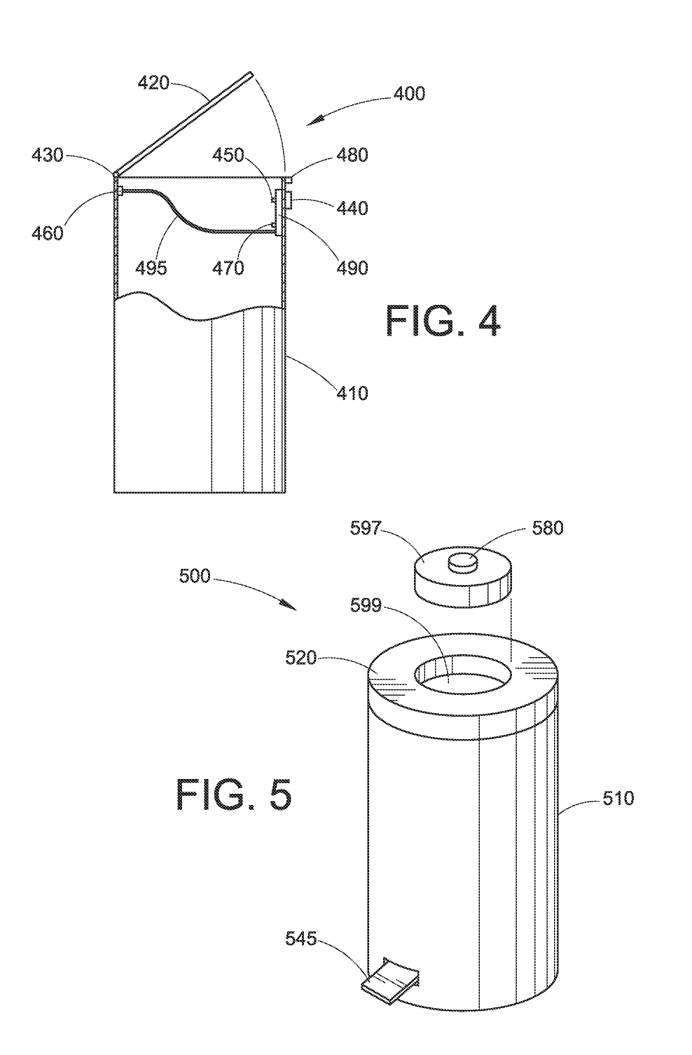

FIG. 4 portrays a fourth embodiment of a waste container 400 of the present disclosure. The waste container 400 comprises a vessel body 410 and a cover 420 which are connected by a hinge 430. The waste container 400 also comprises three odor control dispensers 450, 460, and 470. The first odor control dispenser 450 continuously releases odor control composition. The second odor control dispenser 460 releases odor control composition when the cover 420 moves in relation to the vessel body 410. The third odor control dispenser 470 releases odor control composition when a button 440 is pressed or if a different trigger is activated. All three of the odor control dispensers 450, 460, and 470 draw odor control composition from a common reservoir 490. Odor control dispensers 450 and 470 are attached to the reservoir 490 while odor control reservoir 460 receives odor control composition through tubing 495. The tubing may run within the sidewall of the vessel body 410. Alternatively, all of the odor control dispensers may be directly attached to the reservoir or all of the odor control dispensers may receive odor control composition from the reservoir via tubes. Meter 480 displays the amount of odor control composition remaining with the reservoir 490 and optionally provides a signal when the amount falls below a predetermined level.

FIG. 5 displays a fifth embodiment of a waste container 500 of the present disclosure. The waste container 500 comprises a vessel body 510 and a cover 520 which may be connected at a hinge (not shown). The waste container 500 also includes a foot pedal 545 which may be pressed to open the cover 520. The cover 520 includes a cartridge holder 599 for receiving a cartridge 597. The cartridge 597 includes an internal reservoir (not shown) which holds an odor control composition. A button 580 atop the cartridge 597 acts as a trigger for the release of a portion of the odor control composition from the reservoir. The cartridge 597 may be replaceable and/or refillable. The combination of the button 580 and the foot pedal 545 allow a user to open the vessel body and distribute the odor control composition without using two hands. In other words, the user can carry a waste bag to be disposed of in one hand while operating the waste container 500.

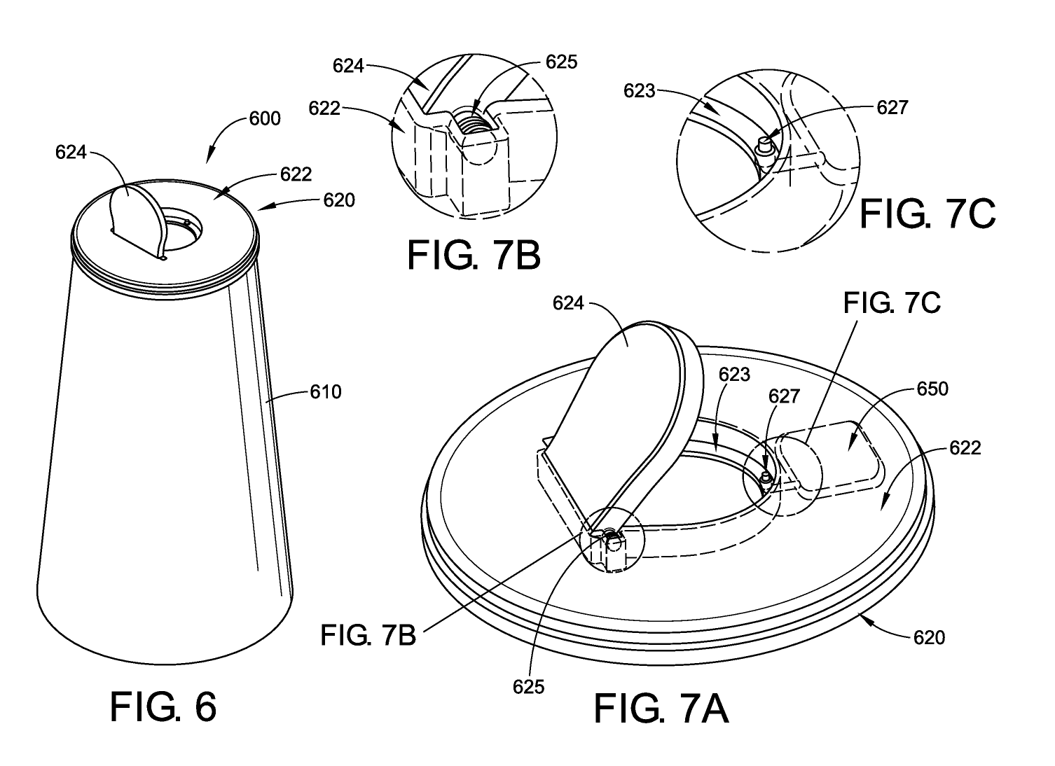

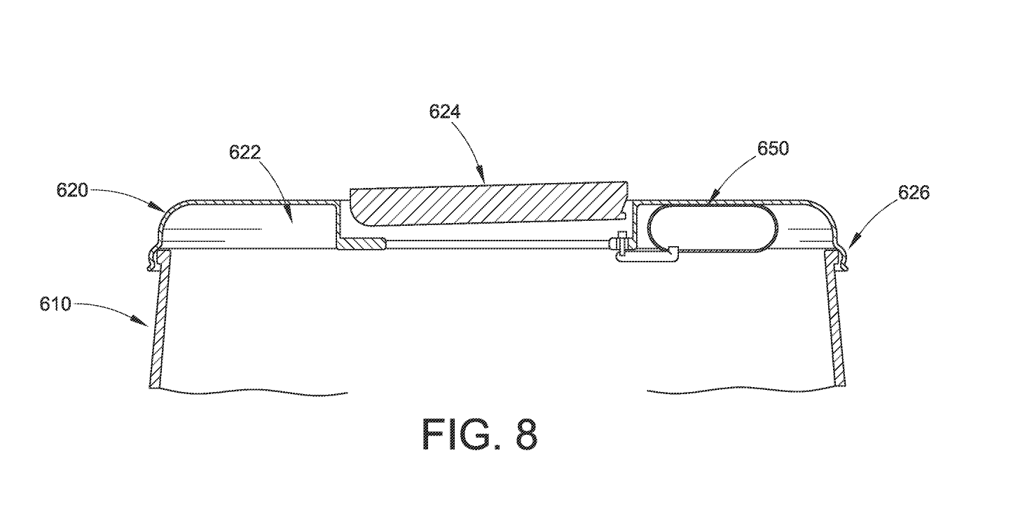

FIGS. 6-8 present a sixth embodiment of a waste container 600 of the present disclosure. The waste container comprises a vessel body 610, a cover 620, and an odor control dispenser 650. The waste container may have a height of about 30 inches. The cover 620 includes an attachment portion 622 and a lid portion 624. The attachment portion 622 may have an outer diameter of about 15 inches. The lid portion 624 may have a diameter of about 5 inches. The lid portion 624 is pivotally connected to the attachment portion 622 by a hinge 625. The hinge 625 may comprise a torsion spring to automatically open the lid 624. The torsion spring may be configured to open the lid at a relatively slow rate to reduce the dispersal of odors. The attachment portion 622 may be connected to the vessel body 610 by snapping on. For example, the attachment portion 622 may comprise a receiving member 626 which receives an outer lip 613 of the vessel body 610. A snapping configuration allows plastic bags to be easily inserted and removed from the waste container 600. The odor control dispenser 650 can be a cartridge which can be attached to the cover 620. The cartridge 650 may be removable and/or refillable. The cartridge may generally be any shape which fits in a corresponding waste container. Non-limiting examples include rectangular, circular, and ring-shaped cartridges. The cartridge may have a capacity of about ½ cup.

The cartridge 650 may be activated by a button 627 located on an inner lip 623 of the attachment portion 620. Activation may occur when the lid 624 is pushed down. This may also cause the torsion spring to open the lid.

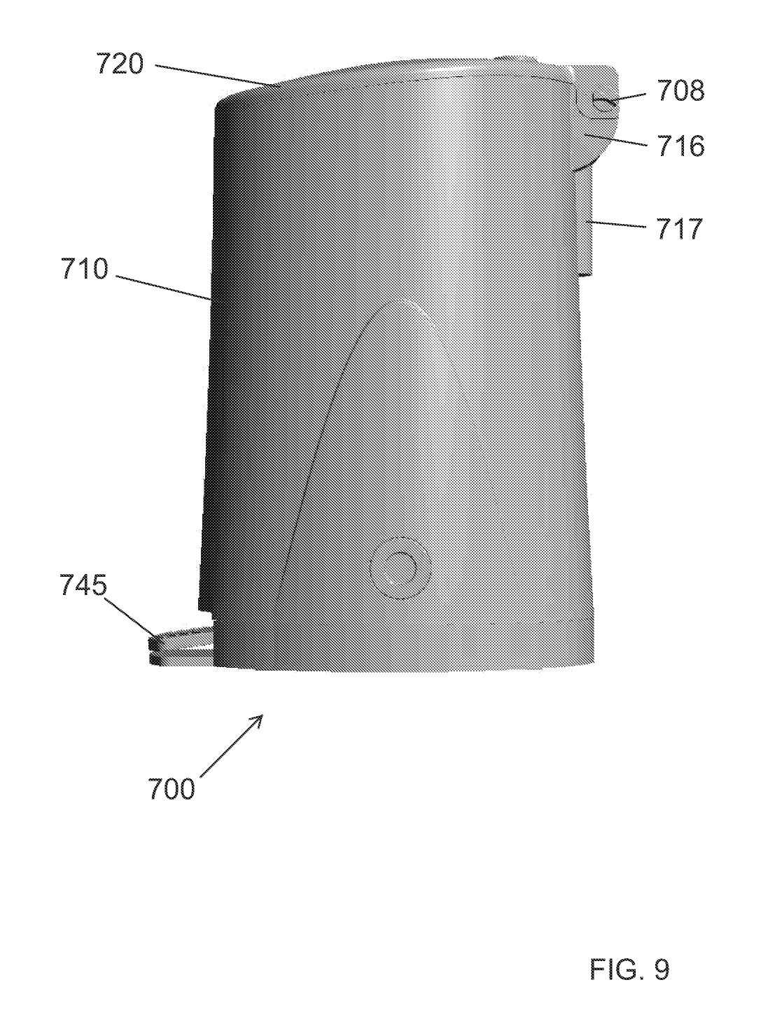

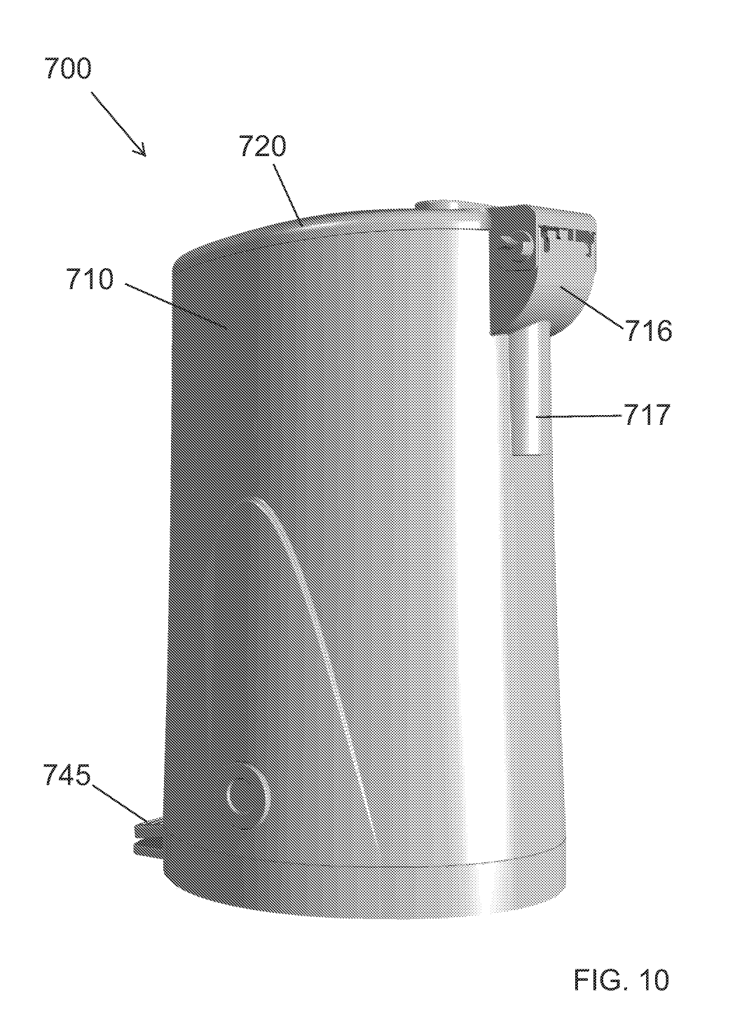

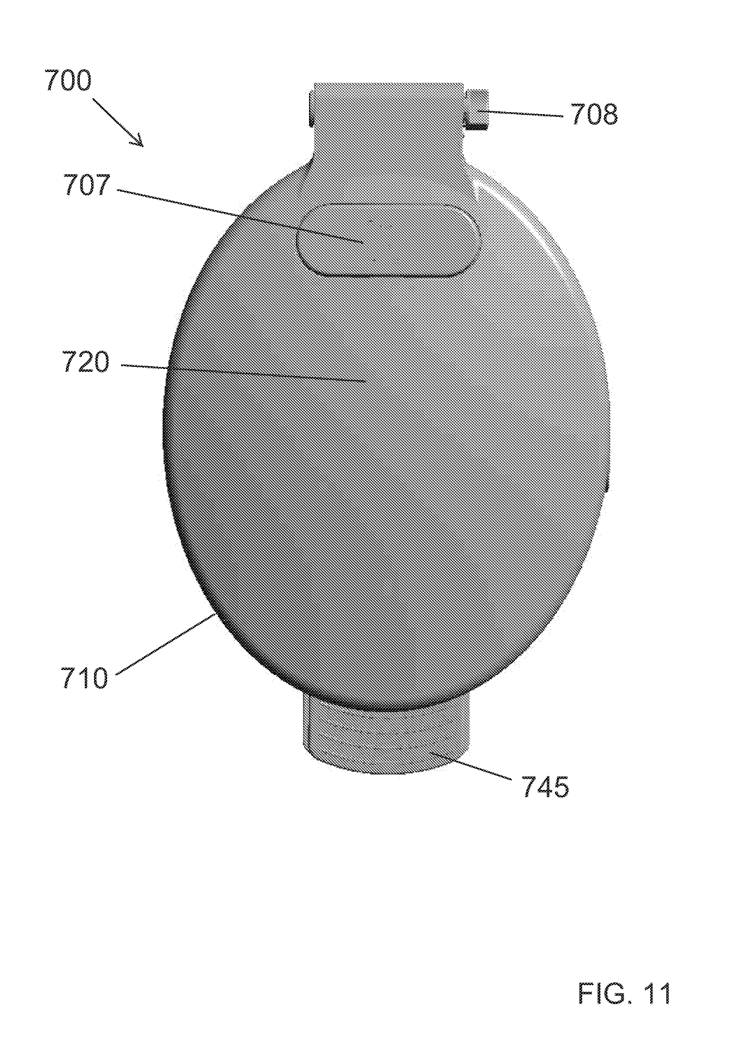

FIGS. 9-21 show various views of another exemplary waste container of the present disclosure. FIG. 9 is an exterior side view. FIG. 10 is an exterior rear perspective view. FIG. 11 is an exterior top view. Generally speaking, the waste container 700 includes an outer vessel body or shell 710, an outer lid 720, an inner vessel body 715, and an inner lid 725. The inner vessel body is separable from the outer vessel body. The outer vessel body 710 has a base at its lower end and an opening at its upper end, and has an empty interior volume. The outer lid 720 rests over the inner lid 715. The inner lid 715 seals the opening of the outer vessel body 710. The inner lid 725 includes a door 726 which opens into the inner vessel body when a predetermined threshold force is exceeded. Waste (e.g., used diapers) may be placed in the inner vessel body when the door 726 is open. The outer vessel body 710 and outer lid 720 are connected by a hinge 730 along a rear end of the outer vessel body. The hinge 730 is configured to open when the foot pedal 745 is pressed. The foot pedal 745 is located on the front end at the base of the outer vessel.

As seen in FIG. 11, the outer vessel body 710 includes a sidewall having a generally elliptical shape. Referring to FIG. 9 and FIG. 10, it should be noted that the rear end of the outer vessel body includes a hinge support section 716 that extends outwards from the top of the outer vessel. A semicylindrical surface or wall 717 is also visible below the hinge support section. The term “semicylindrical” is used here to mean that the surface has the shape of a partial cylinder, and specifically does not require the surface to be that of a half-cylinder. As will be seen later, this semicylindrical wall is part of a cylindrical sidewall that provides a mounting location for the odor control dispenser.

The outer lid 720, foot pedal 745, locking mechanism 708, and outer vessel body 710 are visible in FIG. 9 and FIG. 10. The top view of FIG. 11 also shows a spray button 707 which is located on the outer lid. When the spray button is depressed, the odor control dispenser located inside the outer vessel body dispenses an odor control composition into the waste in the inner vessel body beneath the inner lid 725.

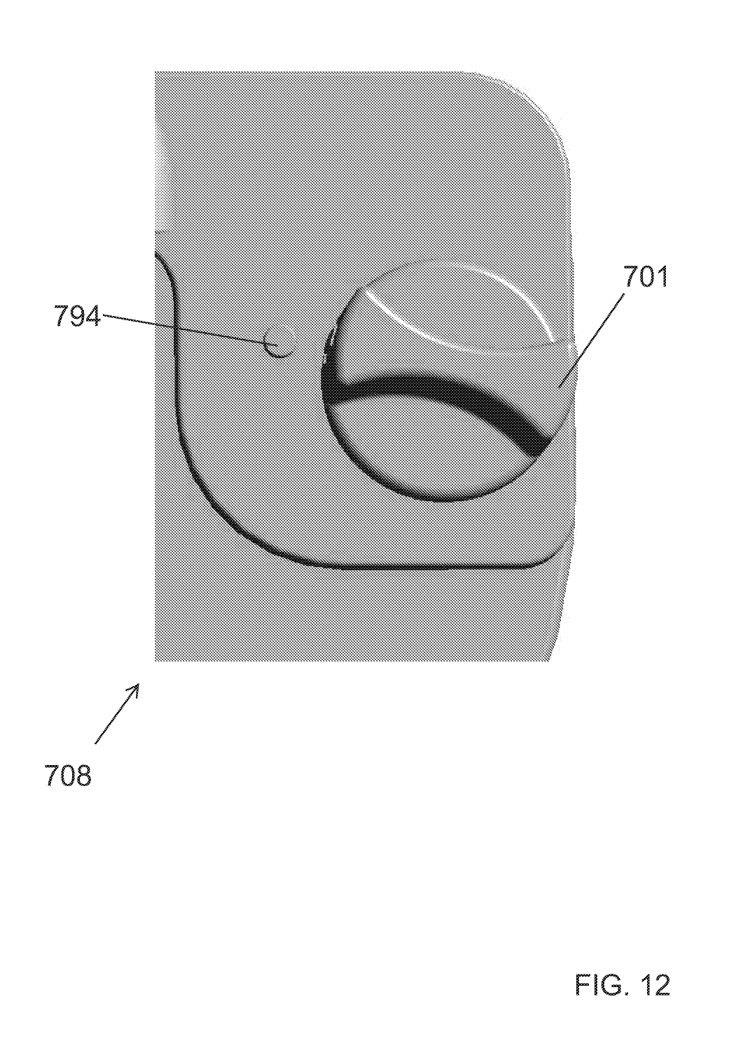

If desired, the outer lid can be locked to remain closed. This may be useful, for example, to prevent children from throwing items into the waste container. FIG. 12 is a magnified view of the locking mechanism used to keep the outer lid in an open (i.e. unlocked) or closed (i.e. locked) position. The locking mechanism 708 includes a locking dial 701 and an alignment dot 794. The locking mechanism 708 is activated when the locking dial 701 is aligned with the alignment dot 794. When aligned, the outer lid is locked closed, and will not open. When not aligned, the outer lid can be opened for waste to be disposed into the inner vessel.

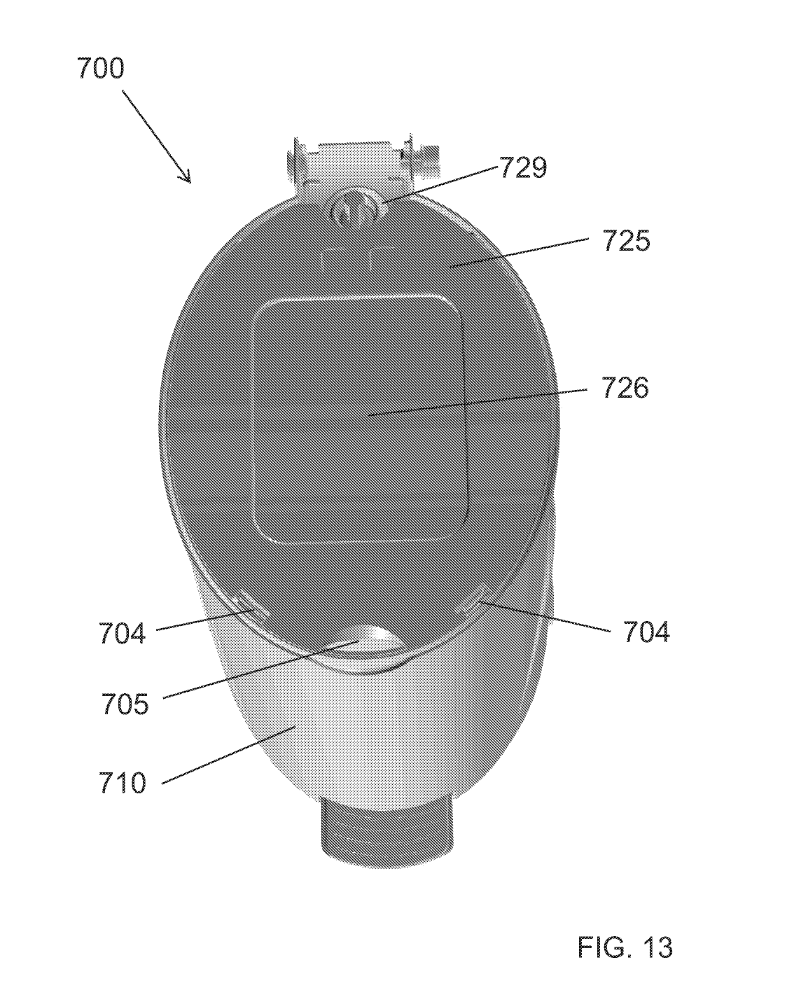

FIG. 13 is a perspective view of the waste container 700 with the outer lid removed to reveal the inner lid 725. The inner lid 725 includes a door 726 in the center and locking tabs 704 about the perimeter to connect the inner lid 725 to the outer vessel body 710. A fingerhold 705 is also present at the front of the inner lid for raising the inner lid. It should be noted that the inner lid contains a cutout 729 on the rear. As will be seen later, this permits the odor control dispenser to be replaced without opening the inner lid. It should be noted that as depicted here, the inner lid does not pivot on a hinge like the outer lid. Rather, the inner lid is fitted over the inner vessel and then locked in place by the tabs 704. However, embodiments are contemplated where the inner lid also pivots on a separate hinge mechanism from the outer lid.

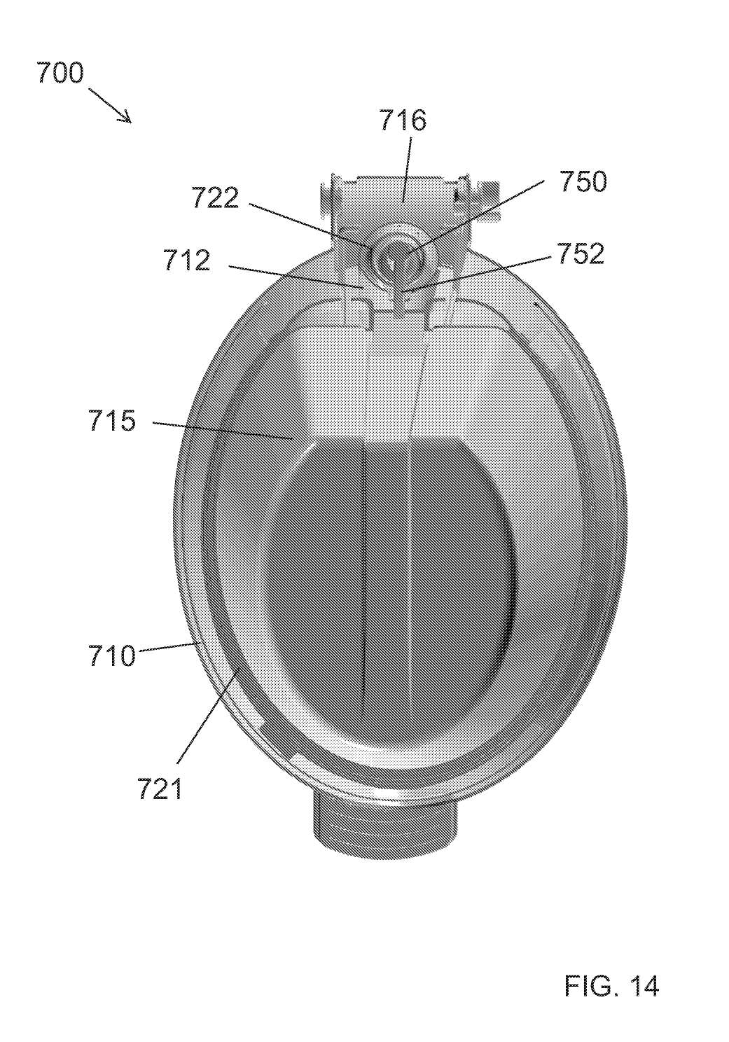

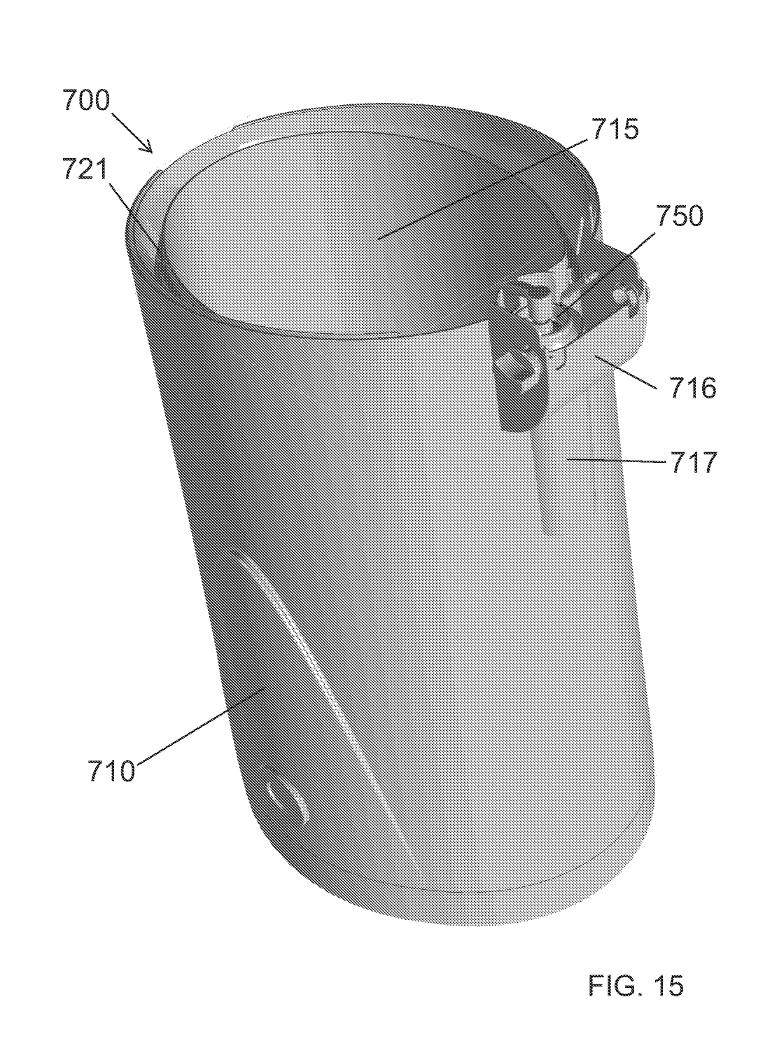

FIG. 14 is a top view of the waste container 700 with both the outer lid and the inner lid removed to reveal the odor control dispenser 750 and the inner vessel body 715. FIG. 15 is a rear perspective view. As previously mentioned, the inner vessel body 715 can be completely separated from the outer vessel body 710. As seen here, the odor control dispenser rests in a cylindrical cavity 722 formed by a cylindrical sidewall 712 and a bottom wall (not visible). The cylindrical cavity is located in the hinge support section 716 between the hinges. The nozzle 752 of the odor control dispenser is sized to be able to spray directly into the inner vessel 715. The nozzle is part of the button that when depressed releases the odor control composition from the reservoir. A portion of the cylindrical sidewall 716 is visible from the rear as the semicylindrical surface or wall 717. The inner vessel 715 also includes a downward lip 721 along the perimeter on the upper edge of the exterior surface.

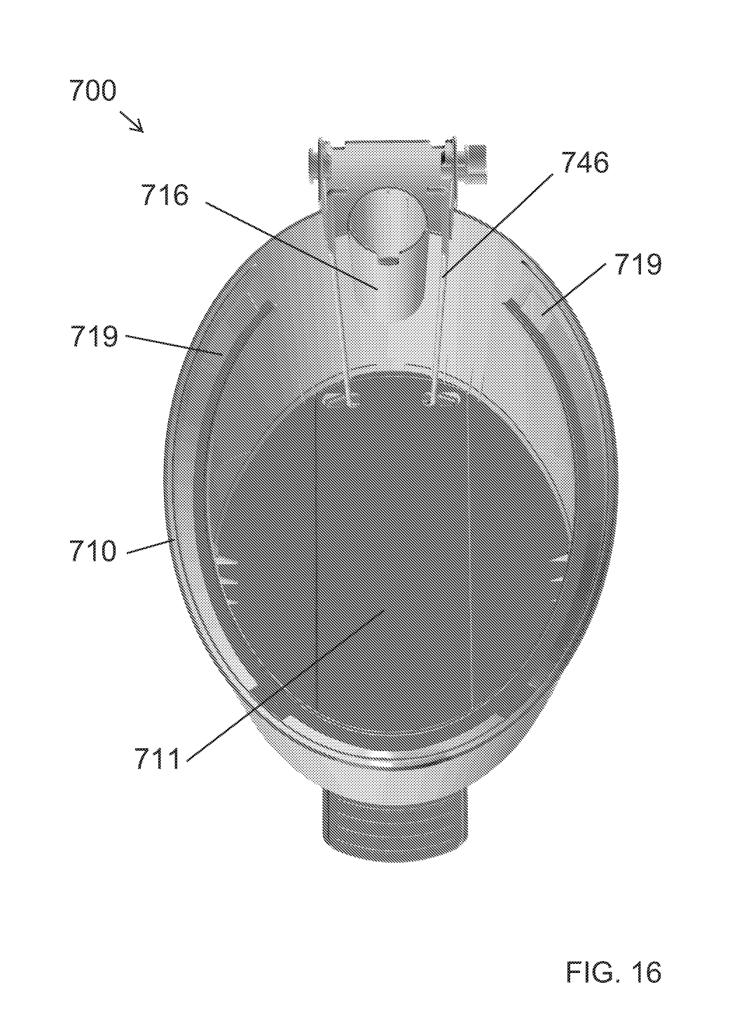

FIG. 16 is a top view of the waste container 700 with the outer lid, the inner lid, the odor control dispenser, and the inner vessel body removed so the interior of the outer vessel body 710 can be seen. The outer vessel body includes a base 711 that supports the inner vessel body. The foot pedal 745 is coupled to lifting rods 746 that will open and close the outer lid. Here, the cylindrical sidewall 716 that surrounds the odor control dispenser is more easily seen. In addition, an upward lip 719 is visible on the upper portion of the interior surface of the outer vessel body. This upward lip can be useful for centering the inner vessel within the outer vessel, trapping a garbage can liner between the downward lip 721 on the inner vessel and the upward lip, and/or for ensuring that waste thrown near the edge of the inner vessel does not fall to the base of the outer vessel. It should be noted also that the locking tabs of the inner lid engage the upward lip.

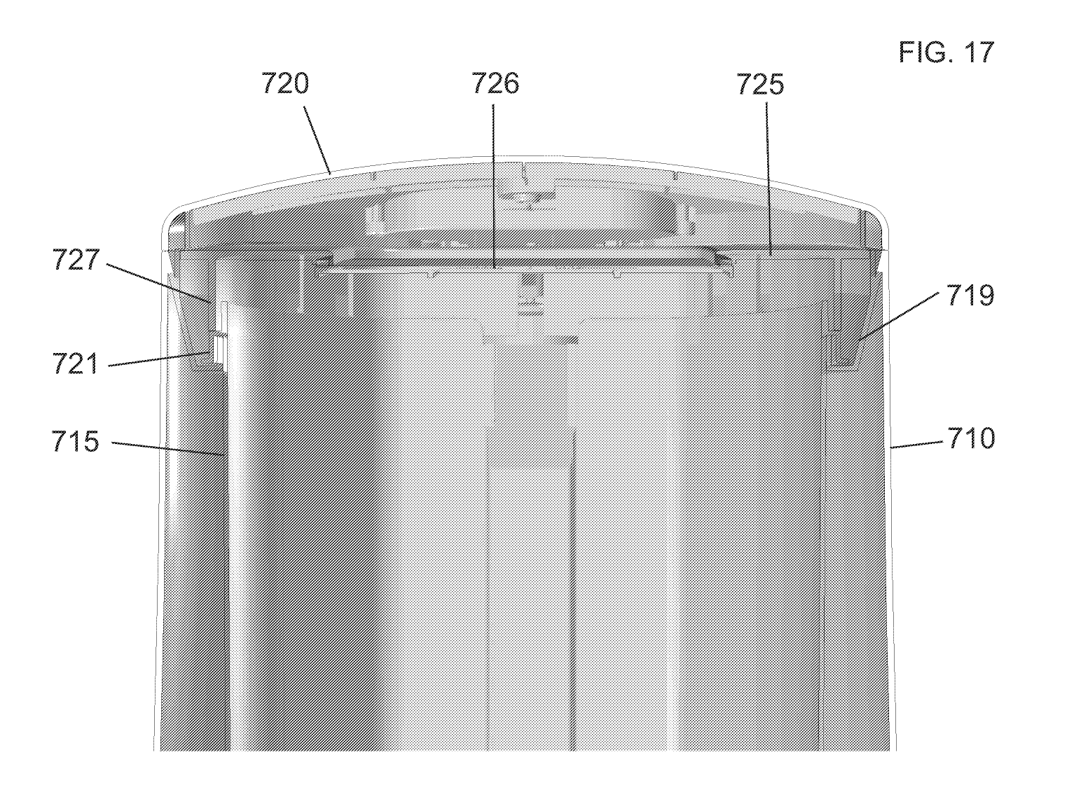

FIG. 17 is a front cross-sectional view of the top of the waste container. In this view, the outer lid 720, inner lid 725, door 726, outer vessel 710, and the inner vessel 715 are shown. The upward lip 719 of the outer vessel body 710 and the downward lip 721 of the inner vessel body 715 can be seen engaging each other. The inner lid 725 also includes a circumferential wall 727 on an interior surface that pushes the upward lip and downward lip together.

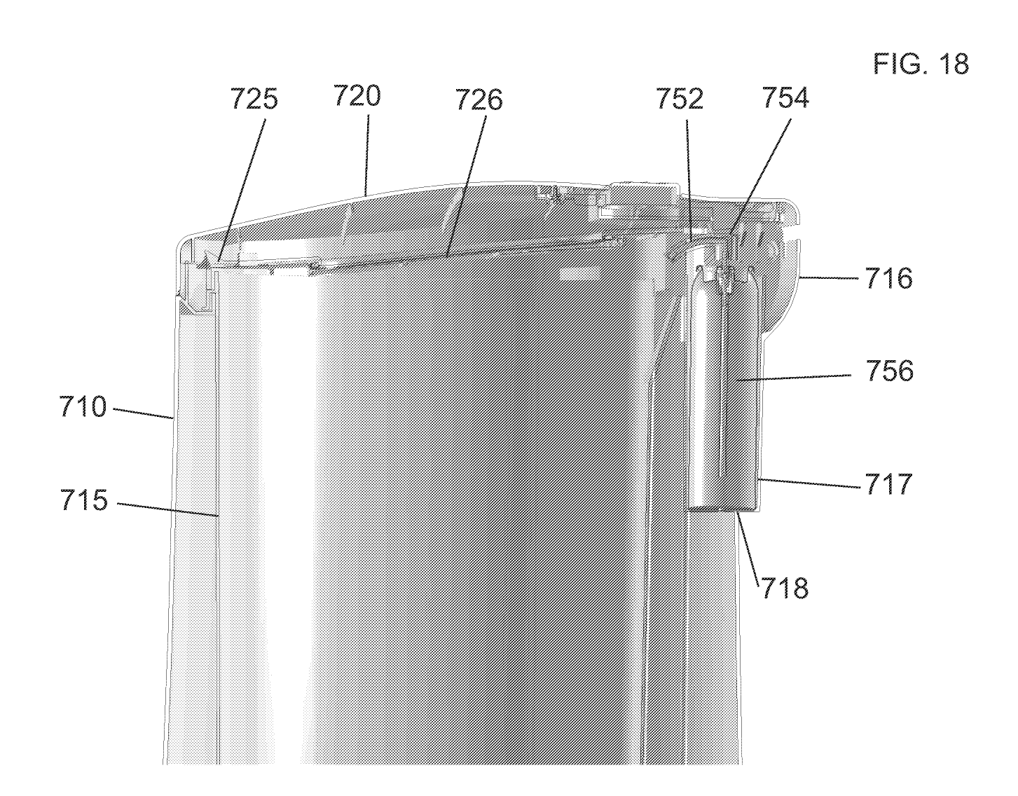

FIG. 18 is a side cross-sectional view of the top of the waste container. In this view, the outer lid 720, inner lid 725, door 726, outer vessel 710, and the inner vessel 715 are again shown. To be particularly noted are the hinge support section 716, the semicylindrical surface 717, and the bottom wall 718 of the cylindrical cavity. Also, the nozzle 752, button 754, and reservoir 756 of the odor control dispenser are visible.

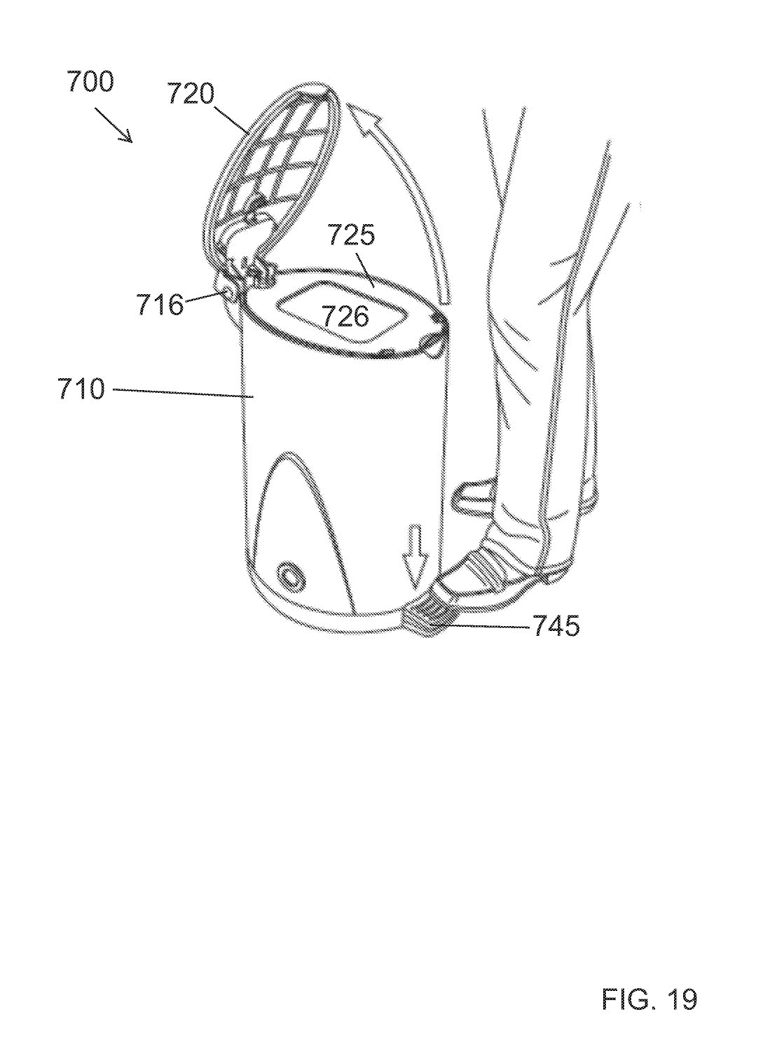

FIG. 19 illustrates the use of the waste container. When the foot pedal 745 is depressed, the outer lid 720 is raised and pivots at the hinge support section 716. The inner lid 725 remains closed. Waste is pushed through the door 726 into the inner vessel.

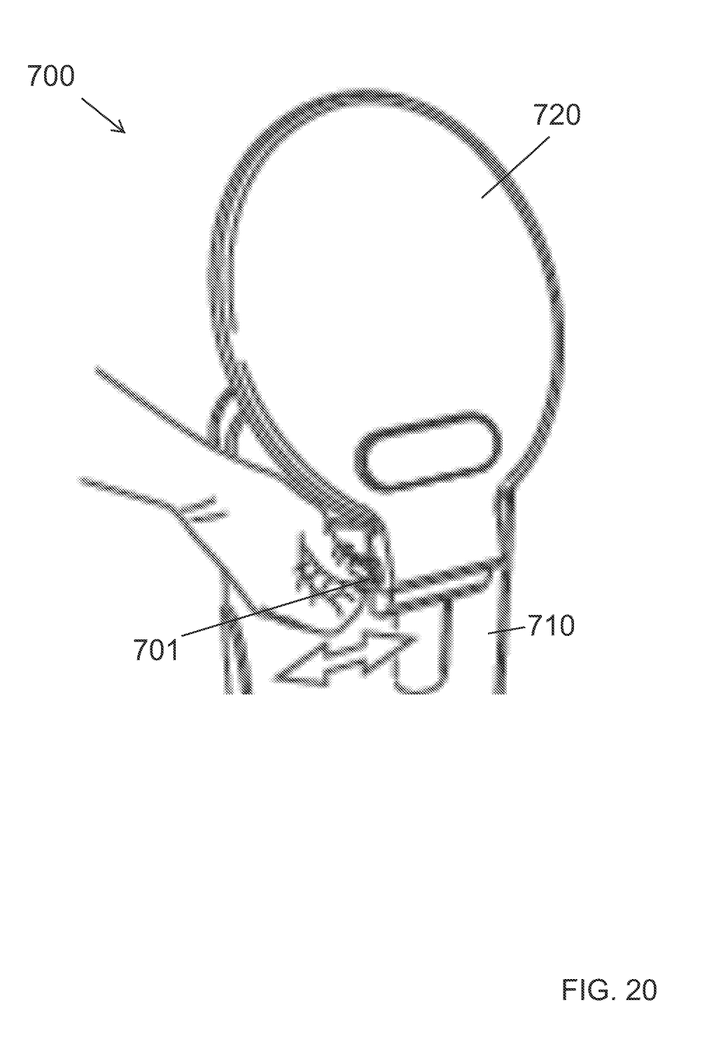

FIG. 20 illustrates how the outer lid 720 of the waste container 700 can be locked in an open or closed position with respect to the outer vessel body 710. As explained in FIG. 12, the foot pedal is first depressed to open the outer lid. The locking dial 701 is pulled out, then rotated to the desired position, then pushed back in.

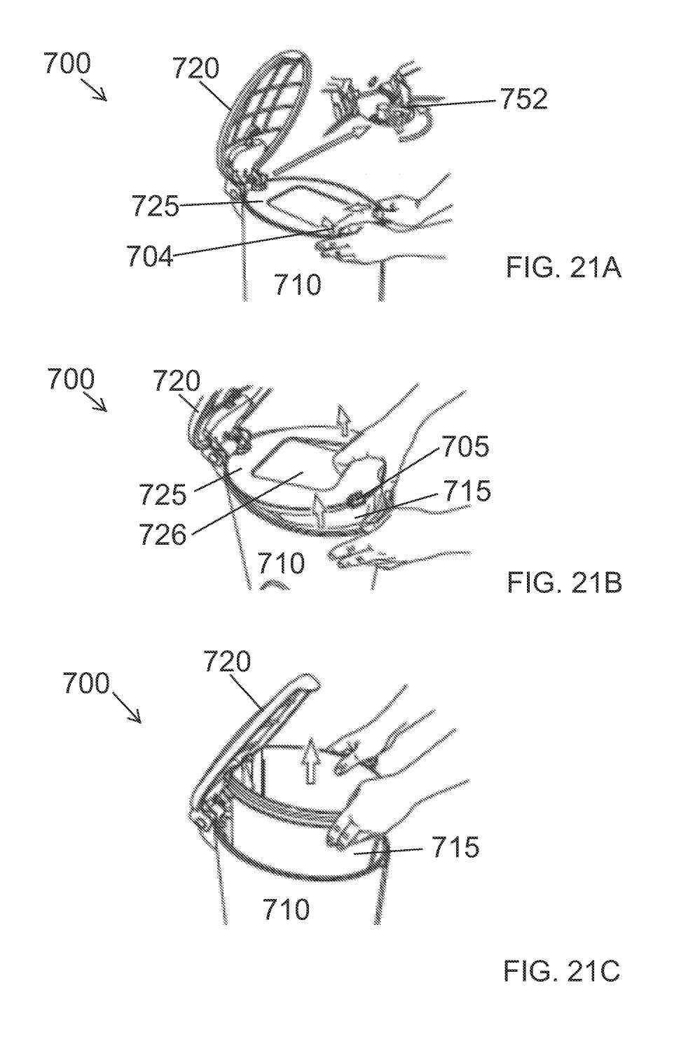

FIGS. 21A-21C illustrate removal of the inner vessel body 715 from the outer vessel body. In FIG. 21A, the outer lid 720 is locked in the open position. The nozzle 752 of the odor control dispenser is swiveled to the side. Then, the locking tabs 704 are pressed to unlock the inner lid 725 from the outer vessel body 710.

Next, in FIG. 21B, the inner lid 725 is removed by placing fingers through the door 726 and the thumb in the fingerhold 705 and pulling upwards. In FIG. 21C, the inner vessel body 715 is removed by pulling it out of the opening created by removal of the inner lid.

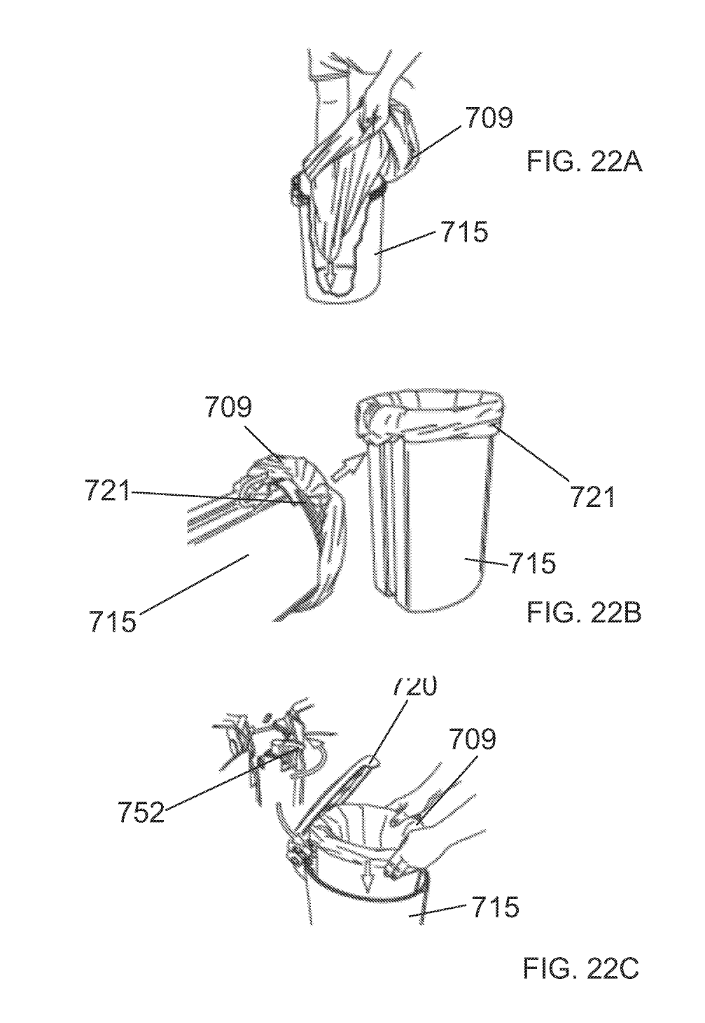

FIGS. 22A-22C illustrate the use of a disposable liner 709 with the inner vessel 715. In FIG. 22A, the disposable liner 709 is inserted into the inner vessel body 715. In FIG. 22B, the edges of the disposable liner are secured under the downward lip 721 of the inner vessel body 715. In FIG. 22C, the inner vessel body 715 with the disposable bag 709 is inserted into the outer vessel body 710 while the outer lid 720 is open. The upward lip on the inside of the outer vessel (see FIG. 16) will engage the downward lip on the inner vessel to keep the liner in place. Again, the nozzle of the odor control dispenser should be swiveled to the side to facilitate these actions.

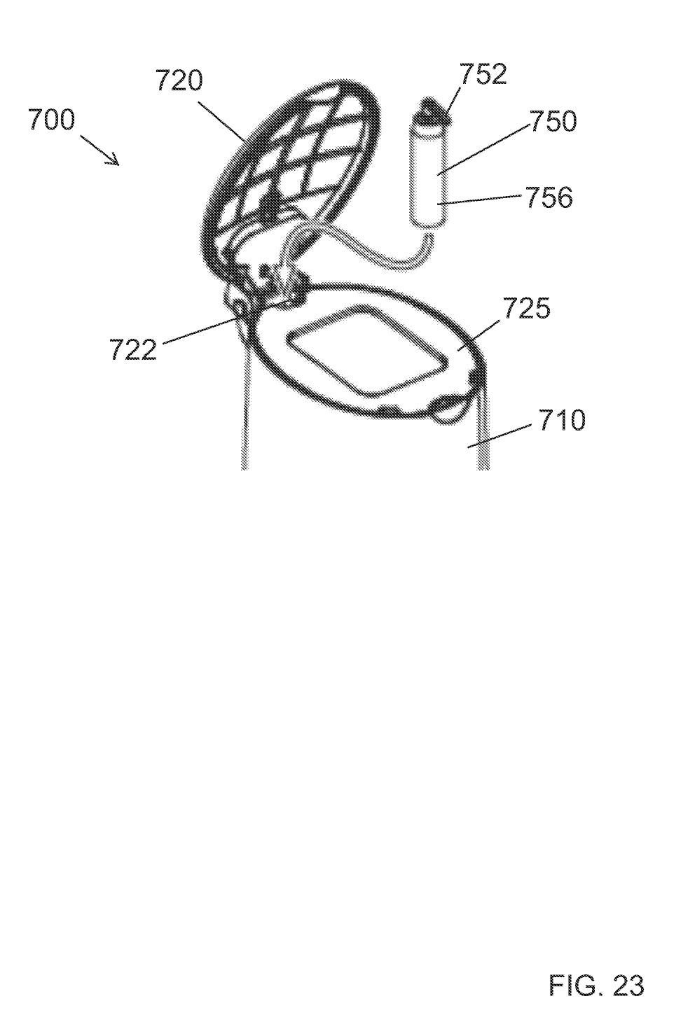

FIG. 23 illustrates the insertion of the odor control dispenser 750 into the waste container 700. The odor control dispenser 750 includes a reservoir 751 for storing an odor control material and a nozzle 752 for injecting the material into the waste container 700. The dispenser 750 is placed into the cylindrical cavity 722. The dispenser is shown here being inserted with the inner lid 725 already fixed in place.

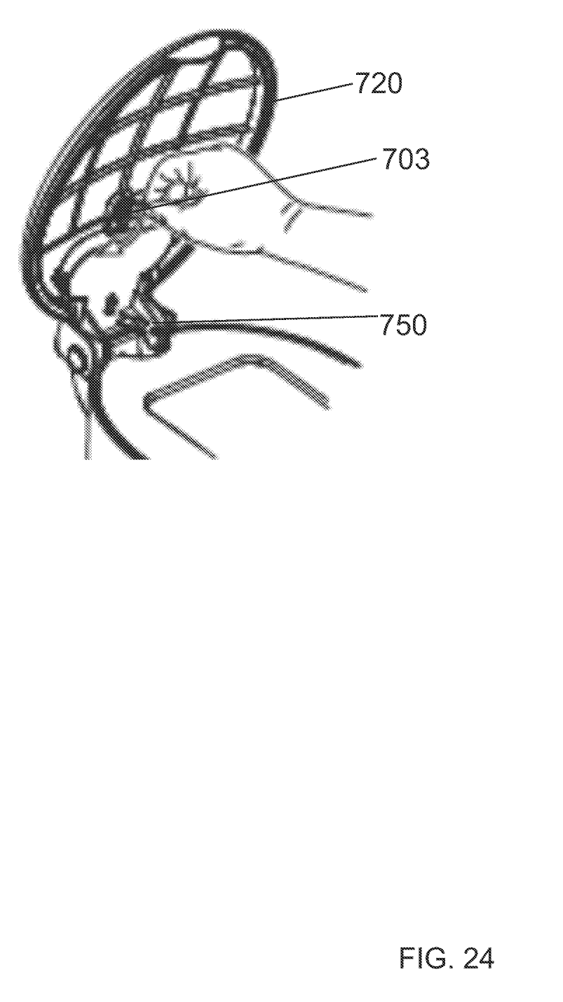

If desired, the spray button 707 of FIG. 11 can be deactivated (e.g. for childproofing purposes. FIG. 24 illustrates the deactivation. Briefly, the button mechanism can be deactivated on the inside of the outer lid 720 by rotating a tab 703 that prevents the button from being depressed. The odor control dispenser 750 is no longer activated by pressing the spray button on the outer lid, but by directly depressing the button on the odor control dispenser.

It should be noted that although the waste container of FIGS. 9-22 is described in terms of an elliptical shape, that the exterior shape of the waste container can be varied as desired. For example, the waste container could have a cylindrical or rectangular shape, or even a spherical shape. The waste container may also be of any desired volume, e.g. relatively small for a medical waste/sharps container to many gallons for a household kitchen or outdoors garbage can.

Some of the waste containers of the present disclosure include multiple odor control dispensers. However, these waste containers may also include only one dispenser. When one dispenser is used, the dispenser may be triggered to release odor control composition by one or more triggers. For example, the single dispenser may release the odor control composition when the cover is moved with respect to the vessel body and/or when a button or foot pedal is pressed.

The single dispenser may also be configured to continuously release a baseline amount of odor control composition in some embodiments. The activation of triggers then increases the rate at which the odor control composition is released.

In embodiments, pressing the button or foot pedal may also cause the cover/lid to open. The waste container may be configured such that the opening of the cover and the release of odor control composition are not simultaneous. For example, after a user presses the button or foot pedal, the odor control composition may be released immediately. However, the opening of the cover may be delayed so that the odor control composition has more time to neutralize odors prior to the user being exposed to smells from inside the vessel body.

Release of the odor control composition may be actuated mechanically via opening and closing of the cover, electronically via an electronic switch on the cover, or by a light-sensitive which. During opening of the cover or lid, an increasing amount of light may reach the switch whereas a decreasing amount of light may reach the switch during closing.

When a single reservoir is used to feed multiple odor control dispensers, the composition released by each odor control dispenser will be the same. In some embodiments, wherein multiple odor control dispensers are used, the compositions released may differ between dispensers.

The odor control composition relates to specific chemicals which react with odor-causing molecules of the waste material. The composition may comprise from about 0.1 to about 5 wt % odor control agents.

In more particular embodiments, the odor control agent is a chloramine. Chloramines are suitable odor control agents based on the ability to release an active Cl⁺ ion when needed on demand, immediately after which, an active aromatic sulfo nitrene companion ion is generated. The Cl⁺ ion starts the conversion process of the odor molecule and is immediately assisted by the companion aromatic sulfo nitrene which completes the conversion process. Specific chloramines include chloramine T, chloramine B, and CH-BENZ.

Chloramine T, illustrated below, is the common name for N-chloro-4-methylbenzenesulfonamide.

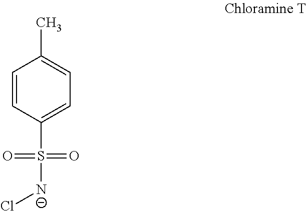

Chloramine T as used herein may also refer to a salt, e.g. as a sodium salt. Chloramine T may also be hydrated. For example, the chloramine T may be a tri-hydrated sodium salt as shown in Formula (I):

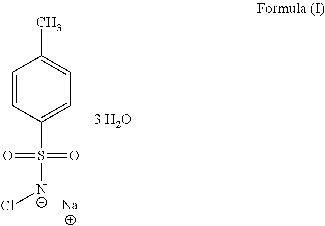

Chloramine B, illustrated below, is the common name for N-chlorobenzenesulfonamide sodium salt.

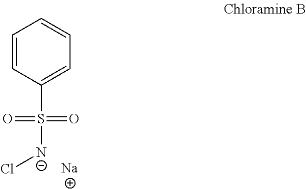 [SMILES: O=S(=O)([N-]Cl)c1ccccc1 ; [Na+]]

Chloramine B may also be hydrated.

CH-BENZ, illustrated below, refers to N-chloro-4-carboxybenzenesulfonamide.

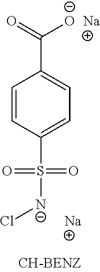 [SMILES: O=C([O-])c1ccc(S(=O)(=O)[N-]Cl)cc1 ; [Na+] ; [Na+]]

More generally, the odor control agent may comprise a halo active aromatic sulfonamide organic compound. The halo active aromatic sulfonamide compounds are in the low to no toxicity range according to Environmental Protection Agency (EPA) standards. The low toxicity of the compounds makes the compounds attractive for use in human and animal environments. The halo active aromatic sulfonamide compounds are in accordance with the following Formulas (II) to (V).

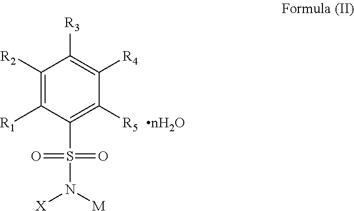

wherein X is a halogen,
R₃ is hydrogen, methyl, or COOM,
R₁, R₂, R₄, R₅ are independently hydrogen, COOH, derivatized COOH, an ester or alkylated amide, COOM, CN, NO₂, SO₃H or derivatized SO₃R, a halogen, a substituted or unsubstituted phenyl group, a sulfonamide, a halosulfonamide, a straight or branched aliphatic moiety from C₁ to C₁₂, wherein, the same straight or branched aliphatic moiety may contain substitution at one or more of the aliphatic hydrogens,
R₁, R₂, R₄ and R₅ are other than all hydrogen,
R is hydrogen or substituted or unsubstituted C₁-C₁₂ alkyl,
and M is an alkali or alkaline earth metal.

Additional compounds which are useful odor control agents are in accordance with Formula (III):

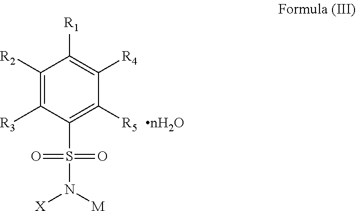

wherein X is a halogen,
R₁, R₂, R₄, R₅ are independently hydrogen, COOH, derivatized COOH, an ester or alkylated amide, COOM, CN, NO₂, SO₃H or derivatized SO₃R, a halogen, a substituted or unsubstituted phenyl group, a sulfonamide, a halosulfonamide, a straight or branched aliphatic moiety from C₁ to C₁₂, wherein the same straight or branched aliphatic moiety may contain substitution at one or more of the aliphatic hydrogens,
R₃ is an organic derivatized COOH, an ester or alkylated amide, CN, NO₂, SO₃H or derivatized SO₃R, a halogen, a substituted or unsubstituted phenyl group, a sulfonamide, a halosulfonamide, a straight or branched aliphatic moiety from C₂ to C₁₂,
wherein the same straight or branched aliphatic moiety may contain substitution at one or more of the aliphatic hydrogens,
and M is an alkali or alkaline earth metal.

Other compounds which are useful as odor control agents are as per Formula (IV):

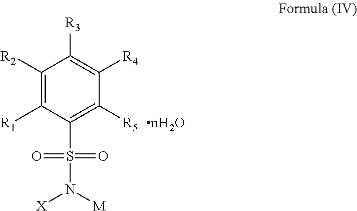

wherein X is a halogen,
R₁, R₂, R₄, R₅ are hydrogen,
R₃ is hydrogen, methyl, or COOM,
and M is either potassium, rubidium, cesium, lithium or an alkaline earth metal.

Other compounds which can be used as odor control agents are in accordance with Formula (V):

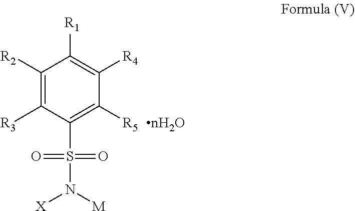

wherein X is bromine, fluorine, or iodine,
R₁, R₂, R₄, R₅ are hydrogen,
R₃ is hydrogen, methyl, or COOM,
and M is an alkali or alkaline earth metal.

Compounds of Formulas (II)-(V) may or may not be hydrated (n H₂O), but are generally isolated as a trihydrate (where n=3).

The compounds of Formulas (II)-(V) are very soluble in water. This property allows for easy compounding of odor control compositions and allows high percentages of the compounds to be formulated into the useful solution products.

Further the compounds of Formulas (II)-(V) have minimal bleach odor. This property again is highly advantageous, because, formulations with strong bleach odor are undesirable in most applications.

The activity of the aromatic chlorosulfonamido group of the compounds of Formulas (II)-(V) is regulated by the selection of specific “R” groups. “R” groups adjacent to the chlorosulfonamido group (R₁ and R₅) can cause steric effects and therefore change activity and/or cause stability changes on the chlorosulfonamido group. In addition the various “R” groups can be effected differently. Specific increases or decreases in activity and, stability may be noted. The usefulness of specific aromatic chlorosulfonamido groups may be affected by their different and unique inductive or resonance effects.

Bleach is commonly used as a source of Cl+ cations which are effective as deodorizers. The term “Cl+” refers to the fact that the chlorine atom has a +1 formal charge in a hypochlorite ion, ClO⁻, which is the form taken by the chlorine atom when dissociated from the sulfonamide compound. A chlorine atom is generally considered to have a charge of 1⁻. Reference to the chlorine atom as having a +1 or 1⁻ charge may be used in this application interchangeably because this terminology has no effect on the compound itself or its use. Because of the problems associated with the use of bleach, i.e. the discoloration of the substrate, and its heavy non discrete oxidizing power, it is generally not suitable for use as a deodorizer. In addition the Cl+ cation which is produced by bleach is much more ionic and non discrete in its reactions when compared to the Cl+ cation produced by the compounds of Formulas (II)-(V). Further, as the compounds of Formulas (II-V) liberate the Cl+ ion, a companion ion an aromatic sulfo nitrene, is released which also is intimately involved in a reaction to convert the odorous molecule to a non-odorous state. That is when compared to the Cl+ cation produced by bleach, the Cl+ cation produced by the compounds of Formulas (II)-(V) is much more covalent and less ionic and therefore is very selective in its initial reaction as a deodorizer, hence, it will attack the odor source and not the substrate. As a result of this covalence the bleaching side effects resulting from the Cl+ cation produced by the compounds of Formulas (II)-(V) do not cause the bleaching problems produced by bleach. Therefore, the Cl+ cation produced by the compounds of Formulas (II)-(V) can be used to deodorize as they do not have side effects such as strong bleach smell etc. Generally it could be said that the compounds of Formulas (II)-(V) are more stable than bleach and have a higher selectivity as a Cl+ source as compared to the Cl+ cation produced by bleach. In addition, the N-halogenated aromatic sulfonamide when activated by an attack on an odorous molecule by its Cl+, further produces an active aromatic sulfo nitrene which also modifies the odor causing molecule in such a manner that it is no longer an odorous molecule.

In summary, compared to bleach the compounds of Formulas (II)-(V) are superior deodorizing agents because they are more selective, more covalent Cl+ and because the backbone companion ion, the aromatic sulfonitrene, remaining after the Cl+ cation is released from the compounds of Formulas (II)-(V), is itself very selective but very active and immediately contributes its odor controlling power. This backbone companion ion has the ability to further react with the odor containing molecule thereby permanently removing it as a potential source of odor. In contrast the chemical moiety which remains after the Cl+ cation is removed from bleach has no ability to react with odor causing molecules.

The odor control agent may also comprise a polymer. Halo active aromatic sulfonamide polymers in particular exhibit little or no toxicity according to EPA standards. The polymer may be of Formula (VI):

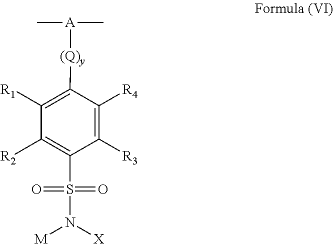

wherein A is a trivalent linkage;
wherein Q is a divalent linkage and y is 0 or 1;
wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen; and
wherein M is an alkali or alkaline earth metal.

In a first specific embodiment of Formula (VI), R₁, R₂, R₃, and R₄ are hydrogen or alkyl; y is 0; X is chlorine, bromine, fluorine, or iodine; and M is an alkali or alkaline earth metal. In a further specific embodiment, X is chlorine and M is sodium or potassium.

In a second specific embodiment of Formula (VI), R₁, R₂, R₃, and R₄ are hydrogen or alkyl; Q comprises an ester (—COO—) linkage where the ester carbon is attached to the benzene group and y is 1; X is chlorine, bromine, fluorine, or iodine; and M is an alkali or alkaline earth metal. In a further specific embodiment, X is chlorine and M is sodium or potassium.

In other specific embodiments, A is —CH₂—CH—.

In other specific embodiments, Q is a methyl formate (—COO—CH₂—) linkage where the —CH₂— is attached to A (not the benzene group) and y is 1.

In a further embodiment, the polymer of the present disclosure has the following Formula (VII):

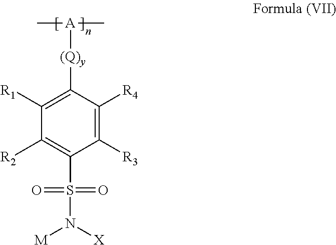

wherein A is a trivalent linkage;
wherein Q is a divalent linkage and y is 0 or 1;
wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen;
wherein M is an alkali or alkaline earth metal; and
wherein n is the degree of polymerization.

In a first specific embodiment of Formula (VII), R₁, R₂, R₃, and R₄ are hydrogen or alkyl; y is 0; X is chlorine, bromine, fluorine, or iodine; and M is an alkali or alkaline earth metal. In a further specific embodiment, X is chlorine and M is sodium or potassium.

In a second specific embodiment of Formula (VII), R₁, R₂, R₃, and R₄ are hydrogen or alkyl; Q comprises an ester (—COO—) linkage where the ester carbon is attached to the benzene group and y is 1; X is chlorine, bromine, fluorine, or iodine; and M is an alkali or alkaline earth metal. In a further specific embodiment, X is chlorine and M is sodium or potassium.

In other specific embodiments, A is —CH₂—CH—.

In other specific embodiments, Q is a methyl formate (—COO—CH₂—) linkage where the —CH₂— is attached to A (not the benzene group) and y is 1.

The polymer may have any polymeric form. For example, the polymer may be a linear polymer, a nonlinear (branched) polymer, a crosslinked polymer, a copolymer, a graft copolymer, or a block copolymer. Similarly, the polymer may comprise only one monomer or several monomers. However, at least one monomer must allow attachment of or subsequent development of the aromatic N-sulfonamide moiety.

The backbone of the polymer comprises a monomer which allows attachment of or subsequent development of the aromatic N-sulfonamide moiety as a pendant group. The simplest backbone is a polyaliphatic backbone such as poly(ethylene), poly(vinyl alcohol), or poly(allyl alcohol). The backbone may also comprise other monomers which do not contain the aromatic N-sulfonamide moiety.

In specific embodiments, the polymer comprises a monomer of the following Formula (VIII):

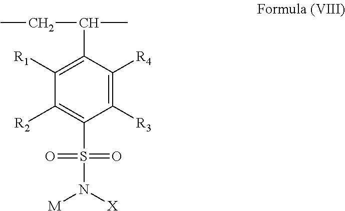

wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen; and
wherein M is an alkali or alkaline earth metal.

In further specific embodiments, the polymer is of the following Formula (IX):

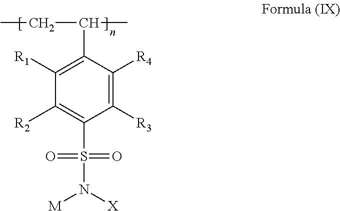

wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen;
wherein M is an alkali or alkaline earth metal; and
wherein n is the degree of polymerization.

In specific embodiments, the polymer comprises a monomer of the following Formula (X):

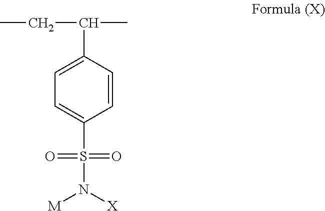

wherein X is chlorine, bromine, fluorine, or iodine; and
M is an alkali or alkaline earth metal.

In a more specific embodiment of Formula (X), X is chlorine and M is sodium or potassium.

In specific embodiments, the polymer has the following Formula (XI):

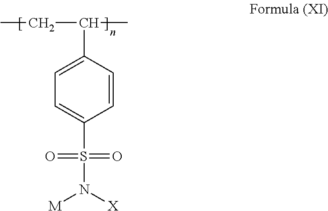

wherein X is chlorine, bromine, fluorine, or iodine;
M is an alkali or alkaline earth metal; and
wherein n is the degree of polymerization.

In a more specific embodiment of Formula (XI), X is chlorine and M is sodium or potassium.

In other specific embodiments, the polymer comprises a monomer of the following Formula (XII):

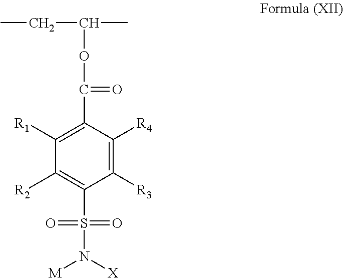

wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen; and
wherein M is an alkali or alkaline earth metal.

In further specific embodiments, the polymer is of the following Formula (XIII):

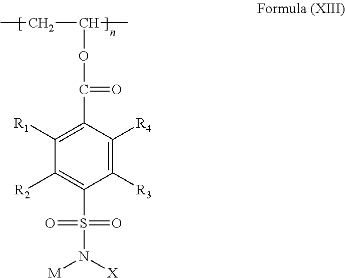

wherein R₁, R₂, R₃, and R₄ are independently selected from hydrogen, CF₃, COOH, derivatized COOH, an ester or alkylated amide, COOM, CN, NO₂, SO₃H or derivatized SO₃R, halogen, substituted or unsubstituted phenyl, sulfonamide, halosulfonamide, and linear or branched alkyl from C₁ to C₁₂, wherein the same straight or branched aliphatic moiety may be substituted at one or more of the aliphatic hydrogens;
wherein X is halogen;
wherein M is an alkali or alkaline earth metal; and
wherein n is the degree of polymerization.

In other specific embodiments, the polymer comprises a monomer of the following Formula (XIV):

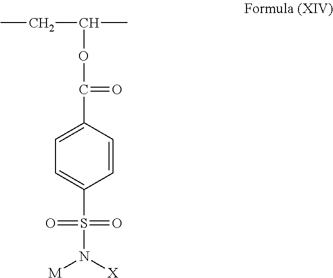

wherein X is chlorine, bromine, fluorine, or iodine; and
M is an alkali or alkaline earth metal.

In a further specific embodiment of Formula (XIV), X is chlorine and M is sodium or potassium.

In specific embodiments, the polymer has the following Formula (X):

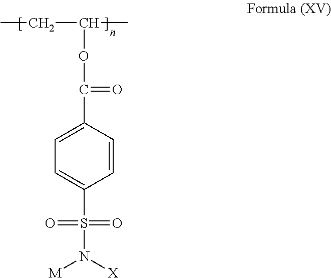

wherein X is chlorine, bromine, fluorine, or iodine; and
M is an alkali or alkaline earth metal.

In a further specific embodiment of Formula (XV), X is chlorine and M is sodium or potassium.

It should be clear that the monomers and polymers shown in Formulas (VIII) through (XV) are all specific embodiments of the monomer and polymer shown in Formulas (VI) and (VII).

In embodiments, the odor control agent itself may act as a disinfectant. The odor control composition may further comprise an additional disinfectant. The disinfectant may be present in an amount of from about 0.1 to about 5 wt % of the composition. Suitable disinfectants include, but are not limited to, chloramine T, chloramine B, and N-chloro-4-carboxybenzenesulfonamide.

In embodiments, a disinfectant composition separate from the odor control composition may also be utilized. In these embodiments, release of the disinfectant composition may be actuated by any of the same triggers used for releasing the odor control composition. This option allows a user to release disinfectant when a more hazardous material is being disposed of.

The odor control composition of the present disclosure may also further comprise one or more fragrances or deodorants. The fragrances and deodorants mask the smell of the contents of the waste container but do not react with odor-causing molecules.

The waste containers of the present disclosure have been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A waste container comprising:
an outer vessel body having a base at a lower end, an upper end with an opening, a hinge support section extending outwards from a rear end on the upper end, and an exterior semicylindrical surface below the hinge support section;
an inner lid for operably sealing the opening of the outer vessel body, the inner lid including a door; and
an outer lid that covers the inner lid.

2. The waste container of claim 1, wherein the door of the inner lid is configured to open into the inner vessel when contacted with a force exceeding a predetermined threshold force.

3. The waste container of claim 1, wherein the outer vessel body and the outer lid are pivotally connected by a hinge in the hinge support section.

4. The waste container of claim 3, wherein the hinge is connected to a foot pedal located at the base of the outer vessel body at a front end of the outer vessel body.

5. The waste container of claim 1, wherein the inner lid further comprises one or more locking tabs that engage the outer vessel body.

6. The waste container of claim 1, wherein the inner lid further comprises a fingerhold on a front end of the inner lid.

7. The waste container of claim 1, further comprising an outer lid locking mechanism that maintains the outer lid in an unlocked configuration when the locking mechanism is in a first position and maintains the outer lid in a closed locked configuration when the locking mechanism is in a second position.

8. The waste container of claim 1, wherein the exterior semicylindrical surface is part of a cylindrical cavity designed to hold an associated odor control dispenser.

9. The waste container of claim 8, wherein the outer lid further comprises a spray button operably configured to depress over the cylindrical cavity.

10. The waste container of claim 8, wherein the inner lid further comprises a cutout configured to permit access to the cylindrical cavity when the inner lid is operably sealing the opening of the outer vessel body.

11. The waste container of claim 1, wherein an upward lip is present on the upper end on an interior surface of the outer vessel body.

12. The waste container of claim 1, further comprising an inner vessel body that fits in the outer vessel body.

13. The waste container of claim 12, wherein a downward lip is present on an upper end of an exterior surface of the inner vessel body.

14. The waste container of claim 13, wherein an upward lip is present on the upper end on an interior surface of the outer vessel body, and the upward lip and the downward lip engage each other.

15. The waste container of claim 12, wherein the inner lid further comprises a circumferential wall that engages the downward lip.

16. The waste container of claim 1, further comprising an odor control dispenser that is adapted to fit in a cylindrical cavity, wherein the exterior semicylindrical surface is part of a cylindrical sidewall surrounding the cylindrical cavity.

17. The waste container of claim 1, wherein the waste container is a pet waste receptacle, a trash can, a diaper pail, a compost container, or a medical waste container.

18. A waste container, comprising:
an outer vessel body having a base at a lower end, an upper end with an opening, a hinge support section extending outwards from a rear end on the upper end, a cylindrical sidewall that forms an exterior semicylindrical surface below the hinge support section, and an upward lip on the upper end of an interior surface;
an inner lid for operably sealing the opening of the outer vessel body, the inner lid including a door and a circumferential sidewall;
an outer lid that covers the inner lid;
an inner vessel body that fits in the outer vessel body, the inner vessel body having a downward lip on an upper end of an exterior surface;
wherein the upward lip of the outer vessel body, the downward lip of the inner vessel body, and the circumferential sidewall of the inner lid are configured to engage each other.

19. The waste container of claim 18, further comprising an odor control dispenser, wherein the outer lid further comprises a spray button operably configured to depress a button on the odor control dispenser; wherein the cylindrical sidewall surrounds a cylindrical cavity in which the odor control dispenser can be placed; and wherein the inner lid further comprises a cutout configured to permit access to the cylindrical cavity when the inner lid is operably sealing the opening of the outer vessel body.
